(19) United States
(12) Patent Application Publication
(10) Pub. No.: US 2015/0135964 A1
(43) Pub. Date: May 21, 2015

(54) SYSTEM AND METHOD FOR PREPARING A BEVERAGE SUITABLE FOR CONSUMPTION

(71) Applicant: Koninklijke Douwe Egberts B.V., Utrecht (NL)

(72) Inventors: Gerbrand Kristiaan De Graaff, Utrecht (NL); Hendrik Cornelis Koeling, Utrecht (NL); Gustaaf Frans Brouwer, Utrecht (NL)

(21) Appl. No.: 14/539,930

(22) Filed: Nov. 12, 2014

Related U.S. Application Data
(63) Continuation of application No. 11/665,391, filed on Jul. 10, 2009, now abandoned.

(30) Foreign Application Priority Data
Oct. 19, 2004 (NL) 1027295
May 31, 2005 (NL) 1029155

(51) Int. Cl. A47J 31/40

(52) U.S. Cl. CPC A47J 31/401
USPC 99/283; 99/287; 99/280

(57) ABSTRACT

A system for preparing a predetermined amount of beverage suitable for consumption includes an exchangeable holder and an apparatus provided with a fluid dispensing device which is detachably connected to the holder for dispensing at least one amount of at least a first fluid such as water under pressure to the exchangeable holder, while the exchangeable holder is provided with at least one storage space which is filled with a second fluid such as a concentrate.

The invention relates to a system for preparing a predetermined amount of beverage suitable for consumption, provided with an exchangeable holder and an apparatus provided with a fluid dispensing device which is detachably connected to the holder for dispensing at least one amount of at least a first fluid such as a liquid and/or a gas, in particular such as water and/or steam, under pressure to the exchangeable holder, while the exchangeable holder is provided with at least one storage space which is filled with a second fluid such as a concentrate.

The invention further relates to an exchangeable holder designed to be connected to an apparatus provided with a fluid dispensing device for dispensing at least a first fluid such as a gas and/or liquid under pressure to the exchangeable holder for preparing a beverage suitable for consumption, while the exchangeable holder is provided with at least one storage space filled with a second fluid such as a concentrate.

Such a system and such an exchangeable holder are known per se.

With the known system, the apparatus is provided with, for instance, a needle which, in use, is pierced through a wall of the storage space for supplying the first fluid to the storage space. In the storage space, the first fluid and the second fluid mix together so that the beverage suitable for consumption is obtained which can then flow from the apparatus to be consumed.

A drawback of the known system is that the strength of the amount of beverage which is dispensed can vary in an uncontrollable manner. The fact is that if at the start of the preparation of the beverage, the storage space still comprises relatively much of the second fluid, the beverage leaving the exchangeable holder will comprise a relatively high concentration of the second fluid and comprise a relatively low concentration of the first fluid. By contrast, at the end of the preparation cycle, the beverage that flows from the holder will comprise a relatively low concentration of the second fluid and a relatively high concentration of the first fluid. Further, with the known system, it is not possible to vary the properties of the beverage in a user-friendly manner, other than by varying the type of first fluid, the type of second fluid and/or the amount of the first fluid or the second fluid. The object of the invention is to provide a system with which, if desired, the above-mentioned drawbacks can be prevented and, furthermore, other advantages can be realized.

Accordingly, the system according to the invention is characterized in that the holder is further provided with at least a first mixing chamber, at least one outflow opening which is in fluid communication with the first mixing chamber for dispensing the beverage from the first mixing chamber, at least one fluid communication between the storage space and the first mixing chamber for dispensing the second fluid to the first mixing chamber, and at least one inlet opening which is detachably connected to an outlet opening of the fluid dispensing device for supplying the first fluid to the first mixing chamber, the system being further provided with a dosing device which is designed to supply the second fluid in a dosed manner from the storage space to the first mixing chamber, while the fluid dispensing device is designed to supply the first fluid under pressure to the first mixing chamber so that in the first mixing chamber the first fluid and the second fluid mix together for obtaining the beverage which, then, leaves the exchangeable holder via the outflow opening.

As presently, the second fluid is dispensed from the storage space to the first mixing chamber in a dosed manner, the concentration of the second fluid in the beverage leaving the first mixing chamber can be accurately controlled. The fact is that the second fluid is dispensed to the first mixing chamber in a dosed manner. The first fluid too can be dispensed by the fluid dispensing device to the first mixing chamber in a dosed manner so that consequently, the properties of the beverage formed by mixing the first fluid and the second fluid in the first mixing chamber can be well defined.

In particular it holds that the dosing device relates to a controllable, active dosing device for supplying the second fluid to the fixed mixing chamber by means of applying an increased pressure or force to the second fluid. Supplying the second fluid to the first mixing chamber can then be controlled as desired. In particular, it holds here that the system is further provided with a control device for controlling the dosing device and the fluid dispensing device. The dosing device and the fluid dispensing device can, for instance, be controlled independently of each other by the control device.

More in general it holds that the system is designed such that the fluid dispensing device and the dosing device can supply the first fluid and the second fluid, respectively, to the first mixing chamber independently of each other. In this manner, the preparation of the beverage can be varied at will by controlling the amount and the period of supply of the first and second fluid independently of each other.

It further preferably holds that the system is further provided with a restriction which is included in a fluid flow path which reaches, via the outlet opening of the fluid dispensing device, the inlet opening of the holder and the first mixing chamber, from the fluid dispensing device to the outflow opening. With the restriction, for instance a jet and/or mist can be generated.

Preferably, it can also hold that the system is further provided with a restriction which is included in a fluid flow path which reaches, via the outlet opening and the inlet opening, from the fluid dispensing device to the first mixing chamber. Here, it holds for instance, that the restriction is designed such that in use, with the restriction, a jet of the first fluid is generated which spouts into the first mixing chamber. As a result, the first and the second fluid can mix well in the first chamber.

In particular it holds that the system is further provided with an air inlet opening for supplying air to the first mixing chamber so that, in use, air is whipped into the beverage for obtaining a beverage with a fine-bubble froth layer. According to a preferred embodiment, it holds here that the air inlet opening forms part of the holder. As the air inlet opening forms part of the exchangeable holder, per exchangeable holder for instance a size of the air inlet opening can be predetermined in order to determine, per exchangeable holder, how much air is whipped into the beverage. Depending on the type of beverage that is to be prepared, the size of the air inlet opening can be determined. If the second fluid involves, for instance, a coffee concentrate and the first fluid, for instance, water, while it is intended that coffee with a fine-bubble froth layer is prepared, the size of the air inlet opening can be chosen to be relatively small. If, by contrast, the exchangeable holder is filled with a second fluid in the form of, for instance, a milk concentrate, while, once more, the first fluid involves water, while it is intended that the beverage consists of frothed milk, the air inlet opening can be relatively large. As the air inlet opening in this example forms part of the exchangeable holder, the consumer needs not set anything. All this can be optimized in advance by the manufacturer.

In particular, it further holds that the restriction forms part of the holder. In this manner too, if desired, the size of the restriction can be predetermined depending on the type of beverage that is to be prepared and, in this example, for instance depending on the type of second fluid present in the storage space. If the restriction is, for instance, relative small, a relatively powerful jet of, for instance, water can be generated. Such a relatively powerful jet may be desirable when the second fluid comprises, for instance, a concentrate with a high viscosity. Here, due to the relatively powerful jet of the first fluid, the concentrate can dissolve well. In this manner too, it can be effected that in the first mixing chamber a relatively strong turbulence is formed of the liquids present there so that, when the air inlet opening is present, relatively much air is whipped into the beverage. Thus, it is advantageous when the restriction forms part of the exchangeable holder.

It preferably holds that the storage space is bound, at least partly, by a movable wall which is movable relative to the rest of the storage space so that through movement of the movable part of the wall, a volume of the storage space can be varied, more particularly that the storage space is bounded, at least partly, by a wall manufactured from a movable, flexible materials such as a foil. In particular is holds here that the dosing device is provided with at least one actuator for moving the movable part of the wall so that the volume is reduced for dispensing the second fluid to the mixing chamber in a dosed manner, more particularly for compressing the storage space for dispensing the second fluid in a dosed manner to the first mixing chamber through compression.

As the storage space is bounded, at least partly, by a movable wall, the volume of the storage space can be reduced with the aid of an actuator for dispensing the second fluid to the first mixing chamber in a dosed manner. Combined, the storage space with the movable wall and the actuator form a dosing device.

According to an advanced embodiment, it holds that the exchangeable holder is provided with a plurality of storage spaces, separated from each other, which are each filled with a second fluid. A first storage space can be filled with, for instance, a coffee concentrate while a second storage space is filled with a milk concentrate. In this manner, coffee with milk can be generated when the first fluid comprises, for instance, water. In particular it holds here that each storage space is bounded, at least partly, by a movable wall which is movable relative to the rest of the respective storage space so that a volume of the respective storage space can be varied through movement of the movable part of the wall, more in particular that each storage space is bounded, at least partly, by a wall manufactured from a flexible or deformable material such as a foil so that through movement of the outer wall a volume of the respective storage space can be varied.

According to a preferred embodiment it further holds that the dosing device is provided with a plurality of dosing devices for dispensing fluids, with several dosing devices, in a dosed manner, from mutually different storage spaces to the first mixing chamber.

In this manner, first, from a first storage space a coffee concentrate can be supplied to the first mixing chamber while the liquid dispensing device can supply the liquid in the form of, for instance, hot water to the first mixing chamber for preparing coffee. Thereupon, from the second storage space, milk concentrate is supplied in a dosed manner to the first mixing chamber, while, also, the hot water is supplied to the first mixing chamber. Here, when further an air inlet opening is present, air can be whipped in, so that a frothed milk is obtained. This frothed milk is then dispensed from the exchangeable holder. Thus, when the coffee and, then, the frothed milk are captured in the same cup, a good cappuccino can be prepared with a white froth layer which is formed by hot milk.

According to an advanced embodiment it holds that between each storage space on the one side, and the first mixing chamber on the other side a closure is present which will open when the pressure which is applied by one of the fluids to the closure rises above a particular value. In particular, here, at least a number of the closures will open at mutually different pressures. When, in this manner, each storage space is compressed by, for instance, one and the same actuator, and hence with one and the same force, as long as the closures are closed, this will result in the pressures in the different storage spaces being equal, and then gradually increasing when the storage spaces are compressed. This will be the case, for instance, when the storage spaces abut against each other with flexible walls and, as it were, form one whole. When, subsequently, the pressure in each storage space rises further, first, at least one closure will open when the pressure in the respective storage space rises above a particular value belonging to the respective closure. At least a number of other closures will then not open yet. The result is that at the at least one closure which opens first, the second fluid can flow away to the mixing chamber so that in the first mixing chamber, under the influence of the liquid, a beverage can be generated. When the compression of the storage places is continued, the pressure in the storage places will generally not rise because the volume of one of the storage places reduces as a result of its emptying. Only when the respective storage space with the opened closure is completely empty, the pressure in the other storage places whose closures are not open yet, will rise further. This will have as a consequence that at a somewhat later moment, at least one of the other closures will open so that from the associated storage space, the respective second fluid can be dispensed to the first mixing chamber for preparing a different beverage. In this manner, first, for instance coffee can be formed and then milk, in particular frothed milk, while first, the coffee can flow from the first mixing chamber into a holder such as a cup after which the frothed milk can flow from the first mixing chamber into the cup so that at least the froth of the milk will float on the coffee, resulting in the formation of an attractive white cappuccino.

More in general it holds that the system is designed to dispense fluids with mutually different flow rates and/or during mutually different periods with at least two different dosing devices from at least two storage spaces. Here, once more, the dosing devices can operate or be controlled independently of the fluid dispensing device. In other words, the first fluid and the second fluids can be dispensed in a controllable manner with mutually different flow rates and/or within mutually different periods.

The air inlet can form part of the apparatus or the holder. In particular it holds that the at least one air inlet is provided with an adjustable valve for setting the size of the airflow. The valve can be controlled by the apparatus as well as by the consumer (manually). The valve can for instance be set depending on the type of beverage to be prepared. The exchangeable holder can for instance be provided with a code, readable by the apparatus, so that the apparatus knows which type of beverage is to be prepared, and in this manner, the apparatus can for instance set the adjustable valve and/or control the liquid dispensing device for determining for instance the pressure, the amount, and the temperature of the liquid which is supplied to the exchangeable holder.

The holder according to the invention is characterized in that the holder is further provided with at least one first mixing chamber, at least one outflow opening which is in fluid communication with the first mixing chamber for dispensing the beverage from the first mixing chamber, at least one fluid communication between the storage space and the first mixing chamber for dispensing the first fluid to the first mixing chamber and at least one inlet opening which, in use, is detachably connected to an outlet opening of the fluid dispensing device for supplying the second fluid to the first mixing chamber, while the storage space forms part, at least partly, of a dosing device and is bounded to this end, at least partly, by a movable wall which is movable relative to the rest of the storage space so that, through movement of the movable wall, a volume of the storage space can be reduced for dispensing the second fluid in a dosed manner from the storage space to the first mixing chamber while, in use, the first fluid is also supplied under pressure to the mixing chamber so that the second fluid and the first fluid mix together for obtaining the beverage which then leaves the holder via the outflow opening.

The invention will presently be further elucidated on the basis of the drawing.

In the drawing:

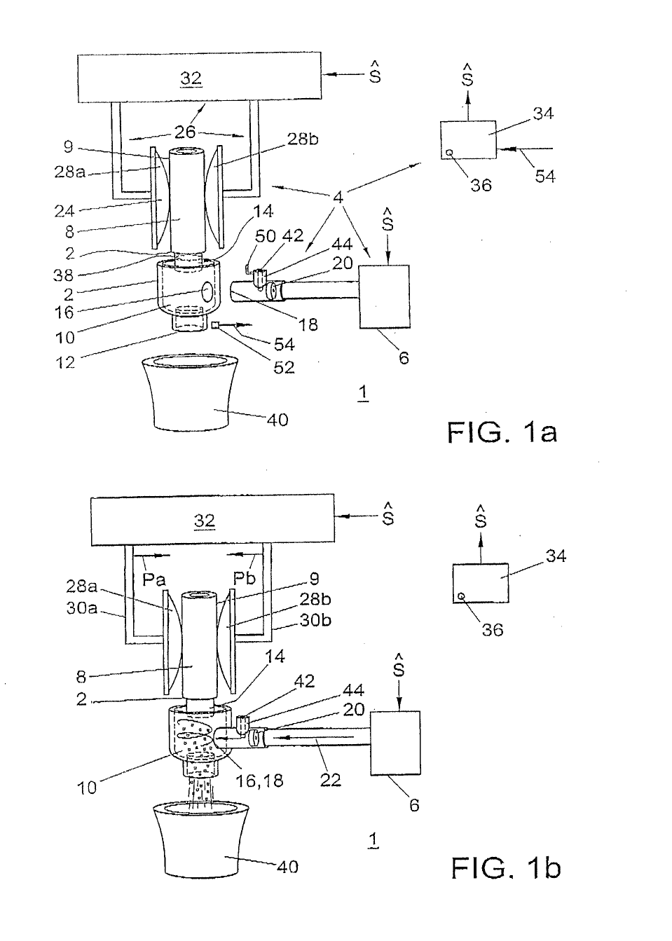

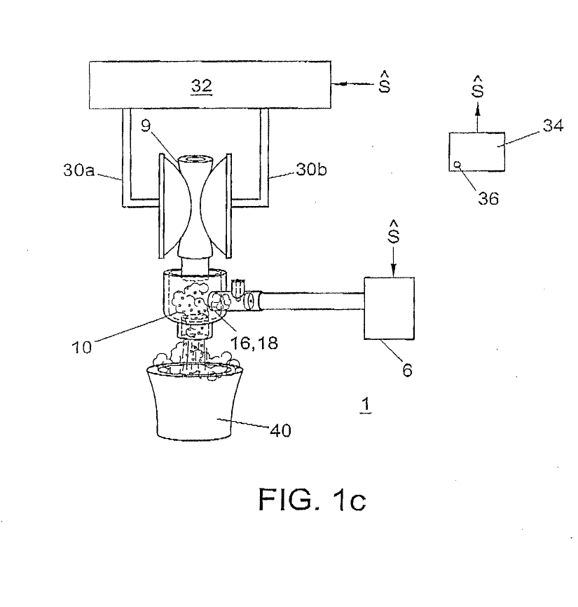

FIG. 1a shows a first embodiment of a system according to the invention provided with a holder according to the invention;

FIG. 1b shows the system according to FIG. 1a in operative condition;

FIG. 1c shows the system according to FIG. 1a in operative condition;

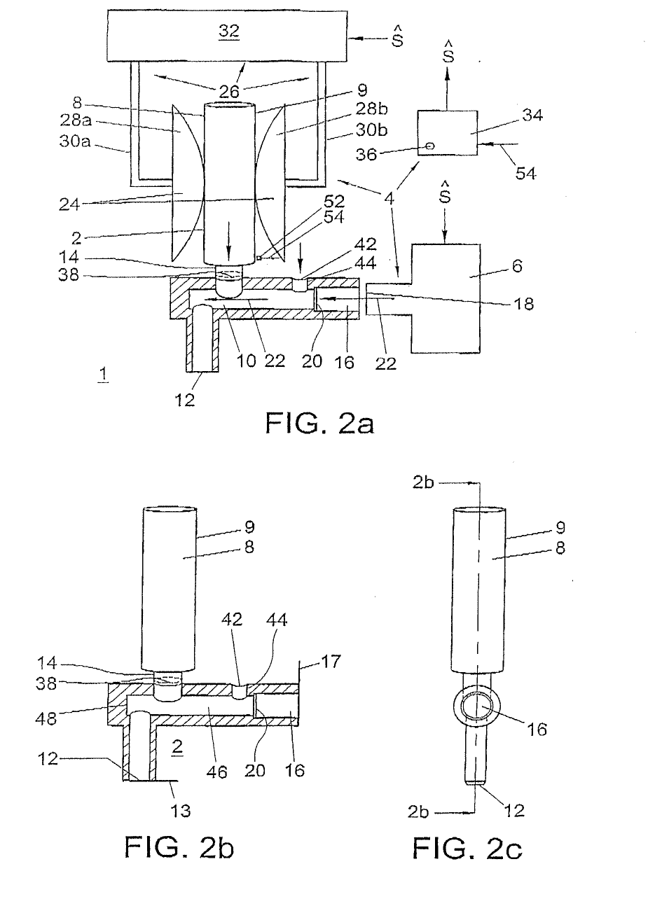

FIG. 2a shows a cross-section of a second embodiment of a system according to the invention provided with a holder according to the invention;

FIG. 2b shows a partly cutaway side view of the holder of FIG. 2a;

FIG. 2c shows a cross-section of the holder according to FIG. 2a;

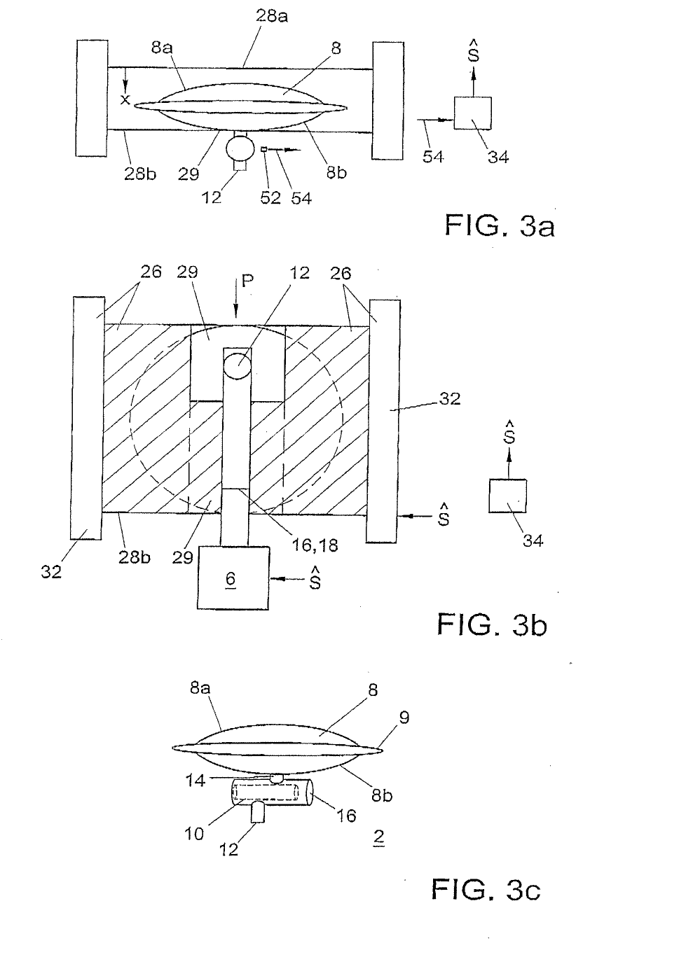

FIG. 3a shows a third embodiment of a system according to the invention provided with a holder according to the invention;

FIG. 3b shows a bottom view of a system according to FIG. 3a;

FIG. 3c shows a side view of the holder of the system according to FIG. 3a;

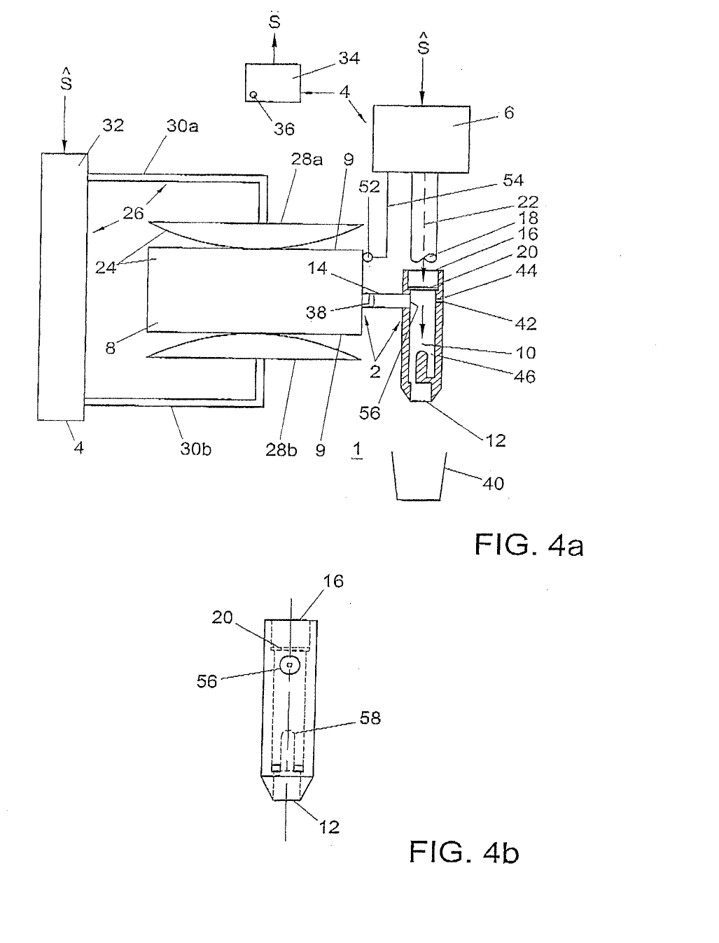

FIG. 4a shows a fourth embodiment of a system according to the invention provided with a holder according to the invention;

FIG. 4b shows a cross-section of a part of the holder according to FIG. 4a;

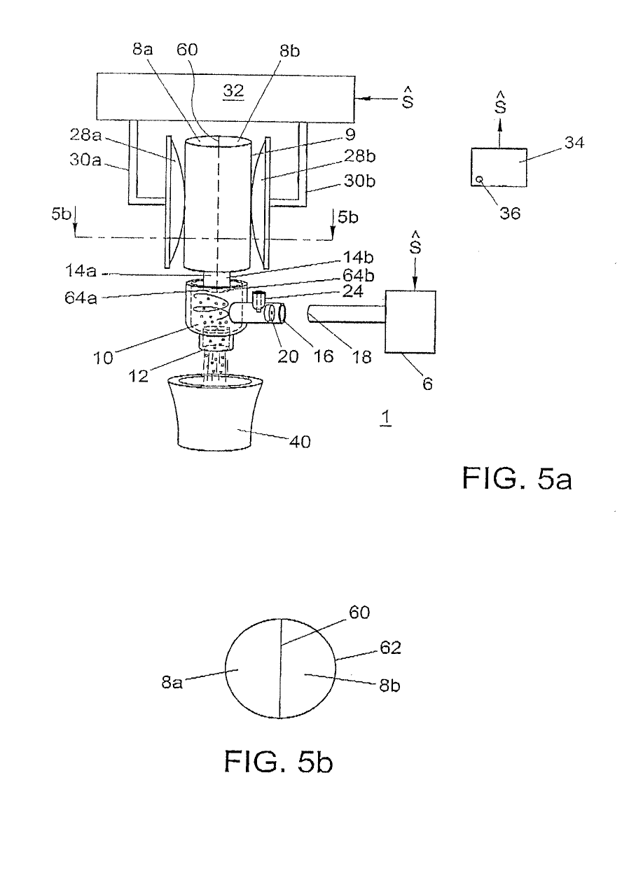

FIG. 5a shows a fifth embodiment of a system according to the invention;

FIG. 5b shows a cross-section of the storage space of the holder according to FIG. 5a;

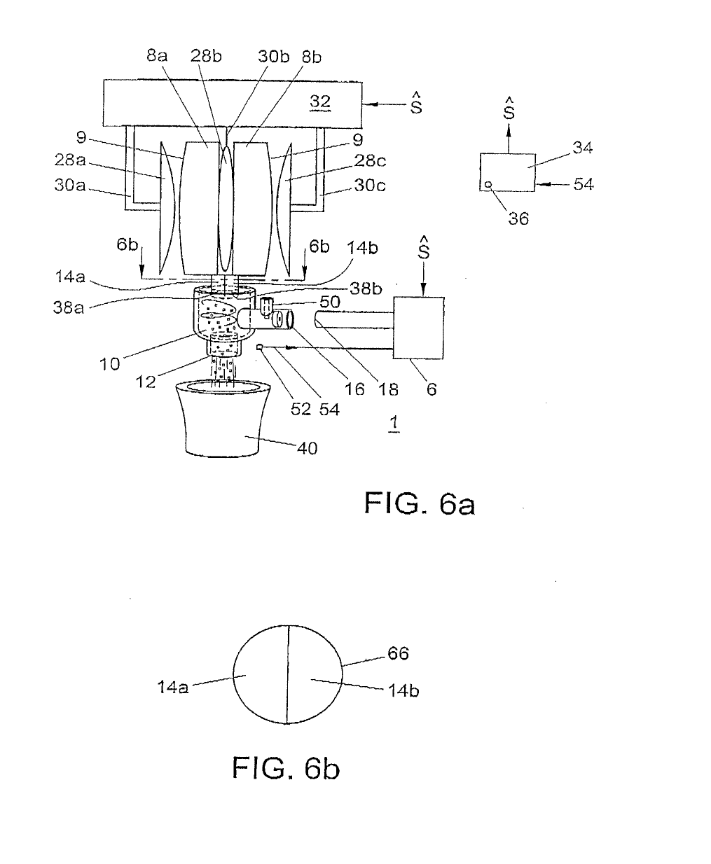

FIG. 6a shows a sixth embodiment of a system according to the invention;

FIG. 6b shows a cross-section of the fluid communication of the holder according to FIG. 6a;

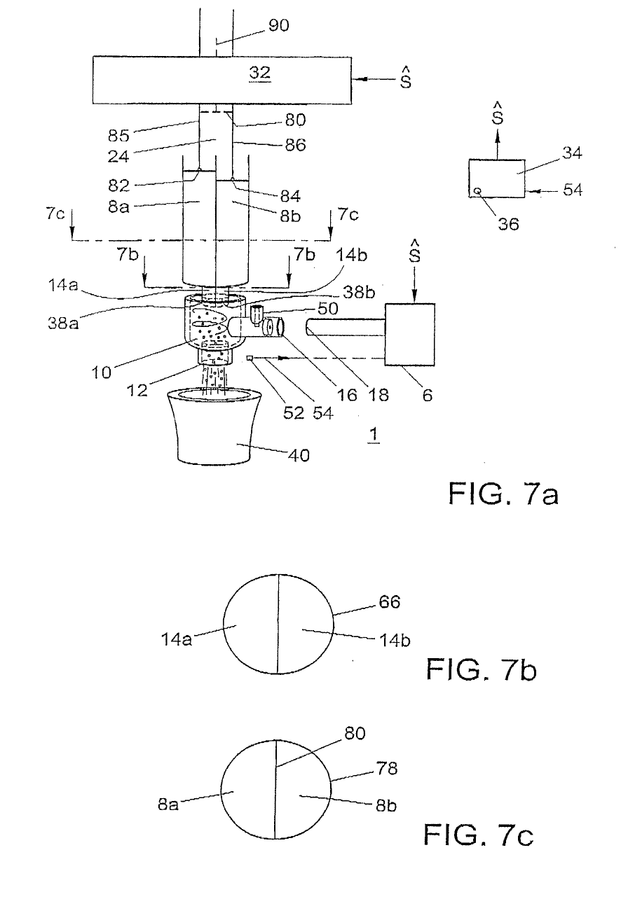

FIG. 7a shows a seventh embodiment of a system according to the invention;

FIG. 7b shows a cross-section of the fluid communication of the holder according to FIG. 7a;

FIG. 7c shows a cross-section of the storage spaces of the holder according to FIG. 7a;

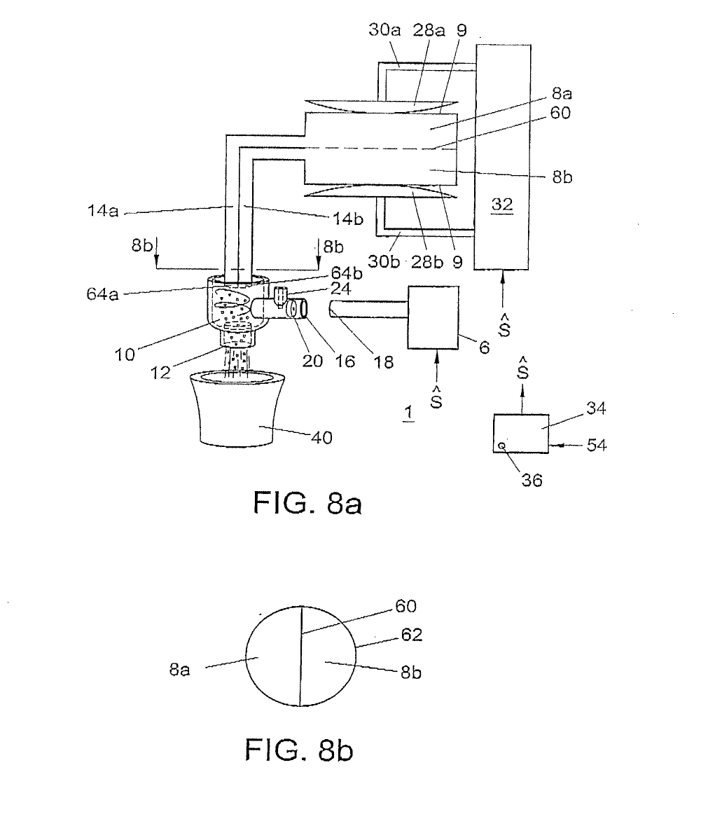

FIG. 8a shows an eighth embodiment of a system according to the invention;

FIG. 8b shows a cross-section of the fluid communication of the holder according to FIG. 8a;

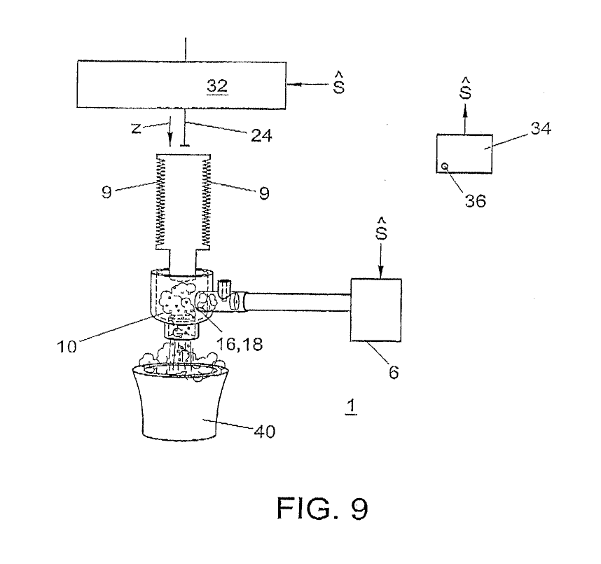

FIG. 9 shows a ninth embodiment of a system according to the invention; and

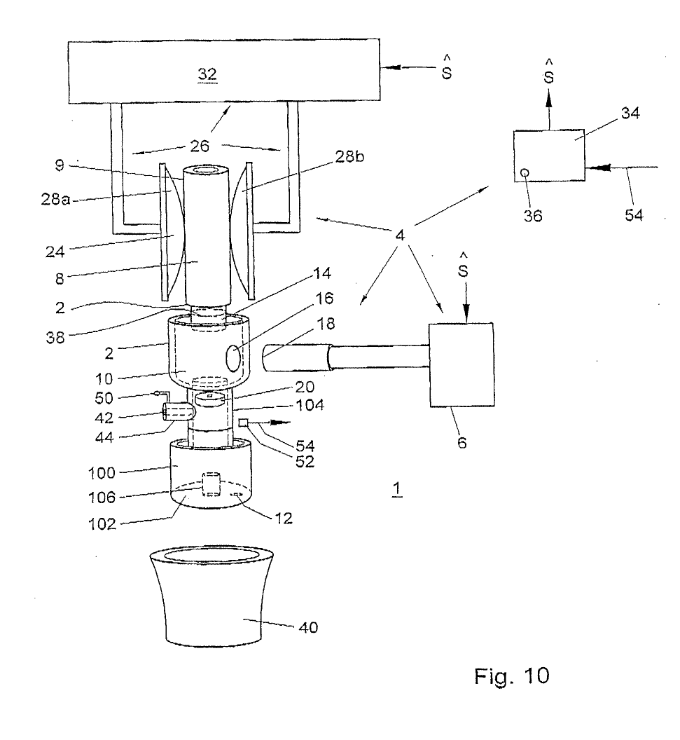

FIG. 10 shows a tenth embodiment of a system according to the invention.

In FIG. 1, reference numeral 1 indicates a system for preparing a predetermined amount of beverage suitable for consumption. The system is provided with an exchangeable holder 2 and an apparatus 4 which is provided with, inter alia, a fluid dispensing device 6 which is designed to dispense under pressure at least one amount of at least a first fluid such as a liquid and/or a gas, more particularly such as water and/or steam. In this example, in use, the fluid dispensing device dispenses water.

The exchangeable holder 2 is provided with at least one storage space 8 which is filled with a second fluid such as a beverage, a concentrate or a powder. In this example, a concentrate for preparing coffee is involved. The holder 2 is further provided with at least a first mixing chamber 10 and at least one outflow opening 12 which is in fluid communication with the first mixing chamber 10. The holder is further provided with a fluid communication 14 between the storage space 8 and the first mixing chamber 10. Furthermore, the holder is provided with at least one inlet opening 16 which is detachably connected to an outlet opening 18 of the fluid dispensing device 6. In FIG. 1a, the inlet opening 16 has not yet been connected to the outlet opening 18. This is however the case in FIG. 1b. In this example, the inlet opening in FIG. 1a is still closed off by a closure which can be removed, such as a removable seal. This also holds for the outflow opening 12. In use, both removable seals are removed whereupon the outlet opening 18 can be connected to the inlet opening 16 as shown in FIG. 1b.

In this example, the system is further provided with a restriction 20 which is included in a fluid flow path 21 which reaches, via the outlet opening 18 of the fluid dispensing device 6, the inlet opening 16 and the first mixing chamber 10, from the fluid dispensing device to the outflow opening 12.

More particularly it holds in this example that the restriction 20 is included in a fluid flow path 22 which reaches, via the outlet opening 18 of the fluid dispensing device 6 and the inlet opening 16 of the exchangeable holder 2, from the fluid dispensing device to the first mixing chamber 10. In this example, the storage space 8 is bounded, at least partly, by a movable wall which is movable relative to the rest of the storage space so that through movement of the movable wall, a volume of the storage space can be varied. In this example, the storage space is bounded, at least partly, by a flexible or deformable material such as a foil. In this example, the wall 9 which bounds the storage space 8 is manufactured at least virtually completely from a flexible material such as a foil.

In this manner, the storage space forms at least a part of a dosing device as will be further set forth hereinafter. This dosing device 24 is further provided with at least one actuator, in this example in the form of a compressing unit 26 for compressing the storage space 8 for dispensing the second fluid in a dosed manner to the first mixing chamber through compression.

In this example, the compressing unit 26 is provided with two pressing members 28a, 28b which are located, in use, on both sides of the storage space 8. The pressing members are connected to a drive 32 by means of arms 30a and 30b. The apparatus 4 is further also provided with a control device 34 for controlling the fluid dispensing device 6 and the drive 32. To control the fluid dispensing device 6 and the drive 32, the control device 34 generates control signals ŝ which are supplied to the fluid dispensing device 6 and the drive 32.

The apparatus described heretofore works as follows. For the purpose of preparing a predetermined amount of beverage suitable for consumption, the exchangeable holder 2 is placed in the apparatus. Here, the storage space 8 of the exchangeable holder is received between the two pressing members 28a, 28b. Also, as shown in FIG. 1b, the outlet opening 18 is connected to the inlet opening 16. The apparatus is now ready for use. By pushing, for instance, a button 36 of the control device 34, the control device provides for the drive 32 to start moving the arms 30a, 30b in the direction of the arrow PA and the arrow PB, respectively. The result hereof is that the pressing members 28a, 28b start compressing the storage space 8. Here, the fluid communication 14 may further be provided with a closure 38 in the form of, for instance, a breakable skin 38 which tears open as a result of the increase of the pressure in the storage space 8 caused by the compression of the storage space 8. As a result, in this example, the coffee concentrate will flow in a dosed manner from the storage space 8 via the fluid communication 14 to the first mixing chamber 10. At the same time, the control device 34 provides for the fluid dispensing device 6 to be activated. This results in the fluid dispensing device 6 starting to dispense the first fluid, in this example water, under pressure. In this example, this water is hot water with a temperature of, for instance, 80-98° C. This hot water flows via the liquid flow path to the restriction 20. Upon arrival at the restriction 20, by means of the restriction 20, a jet of the hot water is generated. This jet spouts via the outlet opening 18 and the inlet opening 16 into the first mixing chamber 10. In the first mixing chamber 10, the hot water will start mixing well with the concentrate. Here, the flow rate at which the concentrate is supplied to the mixing chamber is controlled through the control of the drive 32. The flow rate at which the hot water is supplied to the first mixing chamber is also controlled by the control device through the control of the fluid dispensing device. In the first mixing chamber, as a result of the jet, the concentrate will mix well with the hot water so that the beverage is formed. This beverage can then leave the outflow opening 12 and be captured in, for instance, a cup 40. As, with the system according to the invention, both the dosing of the concentrate over time and the dosing of the hot water over time can be controlled well, it can be ensured that the concentration of the amount of concentrate in the beverage can be accurately determined. Furthermore, it can be ensured that the beverage which, during its preparation, leaves the outflow opening 12 is of constant quality, that is, the concentration of the concentrate in the beverage that is dispensed can be kept constant during dispensing, if desired. The fact is that the flow rate of the water and the flow rate of the concentrate supplied to the first mixing chamber can each, and if desired, be controlled independently of each other. Therefore, more generally, it holds that the system is designed such that the fluid dispensing device and the dosing device, independently of each other, can supply the first fluid and the second fluid, respectively, to the first mixing chamber. This entails that the size of the flow rate of the first fluid and the period during which the first fluid is dispensed are independent (in this example under control of the control device) of the size of the flow rate of the second fluid and the period during which the second flow rate is dispensed.

It further holds that the dosing device relates to a controllable and active dosing device for supplying the second fluid to the first mixing chamber by applying an increased pressure or force to the second fluid. Here, an active dosing device is understood to mean that the second fluid flows through the fluid communication from the storage space to the first mixing chamber as a result of the applied excess pressure or force on the side of the storage space.

In the example, the system is further provided with an air inlet opening 42. The air inlet opening 42 ensures that air is supplied to the first mixing chamber so that in use, air is whipped into the beverage for obtaining a beverage with a fine-bubble froth layer. Thus, a café crème can be obtained. In this example, downstream of the restriction 20, the air inlet opening 42 is in fluid communication with the first mixing chamber 10. In this example, the air inlet opening 42 terminates, via a fluid communication 44, into the fluid flow path 22. In this example it therefore holds that the air inlet opening and the restriction 20 each form part of the apparatus 4.

After the beverage, in this example coffee with a fine-bubble froth layer, has been prepared, the control device 34 stops the fluid dispensing device 6. The control device 34 also ensures that the pressing members 28a, 28b are no longer moved together but, instead thereof, are moved apart. Here, it may be such that the control device first provides that the dispensing of the second fluid to the first mixing chamber is stopped and that thereafter the supply of the liquid is stopped. Thus, the risk of the second fluid contaminating for instance the restriction 20 is reduced.

FIG. 1c shows when the pressing members 28a, 28b are moved together for squeezing the storage space 8 empty at the time the control device 34 will stop the supply of hot water to the first mixing chamber and the arms 30a, 30b will no longer move together but, instead thereof, will start moving apart so that the holder can then be taken from the apparatus again.

Hereafter, a user can remove the exchangeable holder and, if a new amount of beverage is to be prepared, place a new exchangeable holder in the apparatus 4. The new exchangeable holder can be provided with an entirely different type of second fluid such as, for instance, a milk concentrate. When, with the aid of the new exchangeable holder, milk is prepared in a comparable manner as described for the preparation of coffee based on coffee concentrate, in the prepared milk no trace will be found of the type of beverage prepared before that. The fact is that the first mixing chamber forms part of the exchangeable holder and when a new exchangeable holder is placed in the apparatus, also an entirely new and, hence, clean first mixing chamber is placed in the holder. Therefore, contamination cannot be involved.

Now, with reference to FIGS. 2a-2c, a second embodiment of a system according to the intention is described. Here, in FIG. 2, parts corresponding to FIG. 1 are provided with the same reference numerals.

As is clearly visible in FIGS. 2b and 2c, an important difference is that the restriction 20 now forms part of the exchangeable holder 2. Further, it can be seen that the air inlet 42 forms part of the exchangeable holder 2. Here, it also holds, again, that the air inlet opening downstream of the restriction is in fluid communication with the first mixing chamber. In FIG. 1 it held that the first mixing chamber was provided with an inlet opening through which the fluid flow path 22 extended to the first mixing chamber. This inlet opening was, in fact, formed by the inlet opening 16 of the holder as such. In FIG. 2b it can be seen that the inlet opening 16 of the holder does not form the inlet opening of the first mixing chamber 10. The fact is that the restriction 20 is included downstream of the inlet opening 16. As is clearly visible in FIG. 2b, the exchangeable holder is provided, downstream of the restriction rule 20, with an elongated channel 46 in which, downstream of the restriction 20, first, the air inlet 42 terminates and then the fluid communication 40 of the storage space 8. The actual first mixing chamber 10 is in fact located downstream of the restriction in the channel 46.

Before it can be used, the holder, as shown in FIG. 2b, can be provided with a closure 17 which closes off the inlet opening 16, which closure can, however, be removed. Such a closure can, for instance, be a removable seal 17. The holder is also provided with a closure closing off the outflow opening 12, which closure can, however, also be removed. In this example this closure too is provided with a removable seal 13. These removable seals 13, 17 are removed by a user. Then, the exchangeable holder is placed in the apparatus as shown in FIG. 2a. The inlet opening 16 is then connected to the outlet opening 18 of the fluid dispensing device 6 (in FIG. 2a, this connection has not been realized yet). Also, as shown in FIG. 2a, the storage space 8 is, once more, placed between the two pressing members 28a, 28b. Again, a user presses the button 36 to start the preparation of the beverage. Then, the control device 34 provides that the drive 32 moves the arms 28a, 28b together. As a result, as discussed hereinabove, the storage space 8 is compressed. Thus, combined, the storage space 8 and the compressing unit 26 form a dosing device. As the pressing members 28a, 28b move gradually together, the pressure in the storage space 8 will increase. As a result, the breakable skin 38 will tear whereupon, with the pressing members 28 a, 28b moving gradually together further, the coffee concentrate will be supplied to the first mixing chamber 10 in a dosed manner. The control device 34 also provides that the fluid dispensing device 6 is started. Hence, this will start dispensing hot water under pressure. This may be, for instance, at the moment the fluid dispensing device is still activated or some time later so that the first mixing chamber is first filled only with concentrate and then also with the hot water. The hot water flows via the outlet opening 18 of the apparatus 4 to the holder 2. Thus, the hot water is supplied under pressure via the inlet opening 16 to the holder 2. In particular, the hot water flows along the fluid flow path 22 in the direction of the restriction 20. In this manner, at the restriction 20, a jet is formed of the hot water. This jet of the hot water spouts in the direction of an inside wall 48 of the mixing chamber 10. As the air inlet opening 42 is included downstream of the restriction 20, as a result of the venturi effect, air will be drawn in via the air inlet opening 42. Together with the jet, the drawn-in air moves in the direction of the inside wall 48. In the first mixing chamber 10, the air and the hot water will come into contact with the concentrate. As the jet impacts on the inside wall 48, whirls are formed in the first mixing chamber resulting in that air, concentrate and hot water are mixed together, all this in a manner comparable to that of the system of FIG. 1. The thus formed beverage with the whipped-in air leaves the first mixing chamber via the outflow opening 12. Thus, a coffee extract with a fine-bubble froth layer is obtained. When the desired amount of beverage is obtained, the control device 34 stops the fluid dispensing device and the control device 34 will also provide that the arms 30a, 30b no longer move together but, instead thereof, stop moving together to, then, move apart so that the used holder can be removed from the apparatus.

The size of the air inlet opening 42 can be completely geared to the type of beverage that is to be prepared. If a different holder is placed in the apparatus, with which another type of beverage than, for instance, coffee is to be prepared, the air inlet, that is, the size of the air inlet can be adjusted accordingly. For preparing frothed milk based on a milk concentrate, the size of the air inlet 42 can for instance be greater than when coffee extract is to be prepared. For preparing other beverages, with which it is not desired to whip in air, the air inlet 42 can be omitted. It is also possible that the air inlet 42 is provided with an adjustable valve which can be set by, for instance, a user for determining the amount of air that is to be whipped into the beverage. This valve can also be, for instance, set automatically by the apparatus. In the case of, for instance, FIG. 1, the air inlet 42 may be provided with an adjustable valve 50 which is schematically indicated in the drawing. To determine how the valve is to be set for preparing the beverage, the exchangeable holder can be provided with, for instance, a readable code, in the form of, for instance, a bar code or a code stored in a responder known per se. The apparatus is provided with a code reading unit 52 which is connected to the control device 34 by means of a signal wire 54. Via the code reading unit 52, the control device 34 reads a code indicating, for instance, in which manner the valve 50 is to be set. This code can depend on the type of second fluid stored in the holder 2. If a milk concentrate is involved, the code can for instance provide that the valve is opened further than when a coffee concentrate is present. Completely analogously, the apparatus can be designed to also control an adjustable valve 50 of the air inlet 42 when this forms part of the holder as is the case in FIG. 2a. In general, something similar can therefore be used. Also, the fluid dispensing device can dispense, at will, different sorts of first fluids such as steam or water. This choice can for instance be determined by the readable code. If the holder is filled with a concentrate, then, for instance hot water can be dispensed by the fluid dispensing device. If, however, the holder is filled with a beverage such as milk, then, the code of the holder may provide that the fluid dispensing device dispenses steam so that the milk in the first chamber is mixed with the steam for obtaining hot milk.

With reference to FIGS. 3a-3c, schematically, a third embodiment of the system according to the invention is described. Here, parts corresponding to FIGS. 1 and 2 are provided with the same reference numerals.

A difference with the system according to FIG. 2 is that presently, the storage space 8 has a different form. In this example, this is manufactured from a flexible top sheet 8a and a flexible bottom sheet 8b which are interconnected adjacent their circumferential edges while forming a sealing seam. The flexible top sheet 8a and the flexible bottom sheet 8b are each manufactured from, for instance, a liquid-tight foil. The bottom sheet 8b is provided with an opening which is in communication with the fluid communication 14. In the fluid communication 14 once more (not shown) the breakable skin 38 is provided. As the storage space 8 now has a different, more disc-shaped form instead of a cylindrical shape as was the case in FIGS. 1 and 2, the compressing unit 26 has a somewhat different configuration. As can be seen in FIGS. 3a and 3b, the compressing unit is now provided with a plate-shaped pressing member 28a which, in use, is located above the top sheet 8a and a plate-shaped pressing member 28b which, in use, is located below the bottom sheet 8b. In the plate-shaped pressing member 28b, a slot-shaped opening 29 is provided which ensures that the exchangeable holder 2 can be slid into the apparatus in the direction of the arrow P, as shown in FIG. 3b. The storage space 8 will then end up above the pressing member 28b while the first mixing chamber 10, the inlet opening 16 and the outflow opening 12 end up below the pressing member 28b. The slot-shaped opening 29 then provides passage for the fluid communication 14. Also, while sliding the holder 2 in the direction P into the apparatus, the inlet opening 16 will be connected in a fluid tight manner to the outlet opening 18. In use, for dispensing the concentrate from the storage space 8 to the first mixing chamber 10 in a dosed manner, presently, the pressing member 28a will be moved downwards in the direction of the arrow X as shown in FIG. 3a. As a result, the holder 2 will be compressed in vertical direction for dispensing the first fluid, in this example a concentrate, in a dosed manner to the first mixing chamber 10. The operation is further completely analogous to what is described with reference to FIG. 2.

With reference to FIGS. 4a and 4b, presently, a fourth embodiment of a system according to the invention is briefly described. Here, once more, parts corresponding to FIGS. 1 and 2 are provided with the same reference numerals.

The system according to FIG. 4a corresponds, at least substantially, to the system according to FIG. 2a. The difference resides in the form of the first mixing chamber. Here too, a channel 46 is provided which reaches from, for instance, the inlet opening 16 to the outflow opening 12. In this channel 46, which forms part of the fluid flow path 22 mentioned earlier, via the fluid communication 44, the air inlet opening 42 terminates. The fluid communication 14 terminates in this channel 46 too. Downstream of the position 56 where the fluid communication 14 terminates in the channel 46, in this channel, in fact, the first mixing chamber 10 is formed. In the first mixing chamber 10 a jet impact element 58 is included. The jet impact element 58 is therefore situated in the first mixing chamber 10 (see FIGS. 4a and 4b). The restriction 20 is directed relative to the jet impact element 58 such that in use, the jet which is generated by the restriction 20 impacts on the jet impact element. Upon impact of the jet on the jet impact element, the liquid is atomized. Simultaneously, by means of the jet, air will be drawn in through the air inlet opening 42. Also, the concentrate in, the dosing device 24 is supplied in a dosed manner to the first mixing chamber 10. In the first mixing chamber, the hot water and the extract are mixed together well. As the jet impacts on the jet impact element, the jet is furthermore atomized and air can be whipped in well. Then, the thus formed beverage with whipped-in air leaves the first mixing chamber 10 via the outflow opening 12. Here, the beverage can flow around the jet impact element towards the outflow opening 12. The further operation of the apparatus is comparable to what is described with reference to the preceding Figures.

Presently, with reference to FIGS. 5a and 5b, a fifth embodiment of a system according to the invention is described.

In this example, the holder substantially corresponds to what is described with reference to FIG. 1. Presently however, it holds that the exchangeable holder is provided with a plurality of storage spaces 8a and 8b, in this example two, separated from each other. In this example, this is achieved in that, as shown in FIG. 5a, the storage space 8a is separated from the storage space 8b by means of a flexible partition wall 60, such as a foil. Therefore, the storage space 8a, 8b comprises a continuous flexible outer wall 62 such as a foil (see FIG. 5b) which encloses a space divided in two by means of the inside wall 60 (see FIG. 5b). The first storage space 8a terminates, via a first fluid communication 14a, into the first mixing chamber 10. The second storage space 8b terminates, via a fluid communication 14b into the first mixing chamber 10. The second storage space 8b terminates via a second fluid communication 14b in the first mixing chamber 10. The fluid communication 14a comprises a through-flow opening 64a while the fluid communication 14b comprises a through-flow opening 64b (see FIG. 5a). It is noted here that for the sake of clarity, in FIG. 5a not all reference numerals are included that have been included in FIG. 1a. The operation of the apparatus is as follows.

Completely analogously to what is described hereinabove, the inlet opening 16 and the outflow opening 12 are cleared through removal of the earlier mentioned seals. After this, the holder 2 can be placed in the apparatus 4. The inlet opening 16 is then connected to the outlet opening 18 in a fluid-tight manner. The user starts the process for preparing the beverage by energizing the button 38. As a result, completely analogously to what is described hereinabove, the control device 35 provides that the fluid dispensing device 6 is started for dispensing, under pressure, the first fluid, in this example hot water. Thus, a jet is generated with the aid of the restriction 20, which jet spouts into the first mixing chamber 10. The control device 34 also provides that the pressing members 28a, 28b are moved together. In this example, once more, the fluid communication 14a is closed off by a breakable skin 38a while the fluid communication 14b is closed off by means of a breakable skin 38b. Completely analogously to what is discussed hereinabove, the outside edge 62 of the storage spaces 8a, 8b will be pressed together. The result is that the pressure starts rising both in the storage space 8a and in the storage space 8b. Here, the breakable skins 38a, 38b may be constructed such that first the breakable skin 38a opens as it is, for instance, of thinner design. If then the storage space 8a is filled with a coffee concentrate, first of all, coffee concentrate will be supplied to the first mixing chamber. Thus, first, coffee is formed which leaves the mixing chamber via the outflow opening 12. When the pressing members 28a, 28b are moved further together, the pressure in the storage space 8b will not rise further significantly because the storage space 8a is slowly squeezed empty. Only when the storage space 8a is at least virtually empty, so that all coffee concentrate has disappeared from the storage space 8a and has been used for preparing coffee, then, when the pressing members 28a, 28b are moved further together, the second breakable skin 38b which is, for instance, slightly thicker than the first breakable skin 38a, will tear open. This means that only when at least virtually all coffee concentrate has been dispensed from the storage space 8a to the first mixing chamber, the fluid from the storage space 8b will be supplied to the first mixing chamber in a dosed to manner. The fluid at the storage space 8b can for instance consist of milk concentrate. The result is that then, while hot water is being supplied, milk is generated in the first mixing chamber. Furthermore, as a result of the air inlet opening 42, frothing milk will be created. This frothed milk will then end up on top of the coffee extract already present in the cup 40, while the frothed part of the milk will float on top of this. Thus, a perfect cappuccino is obtained.

Further, other variants are conceivable. For instance, the through-flow opening 64a can be designed to be greater than the through-flow opening 64b. When for instance the tearable skins 38a and 38b open exactly at a similar pressure and will therefore, in this case, open at least virtually simultaneously, then, when the outer wall 62 is compressed, first, the pressure in the storage space 8a and 8b will rise to an equal extent. When, thereupon, the two tearable skins 38a, 38b break approximately simultaneously, via the through-flow opening 64a, coffee concentrate will be supplied from the storage space 8a to the first mixing chamber 10. At the same time, milk concentrate will be supplied from the storage space 8b to the first mixing chamber 10. Both concentrates will mix with the jet of the hot water which is supplied by the fluid dispensing device 6 to the first mixing chamber 10. Thus, a beverage is formed consisting of coffee with milk, and which is captured in a mug 40 when the beverage leaves the first mixing chamber 10 via the outflow opening 12. However, as the through-flow opening 64a in this example has a much greater surface than the through-flow opening 64b, the flow rate of the coffee concentrate that is supplied to the first mixing chamber will initially be greater than the flow rate of the milk concentrate that is supplied to the first mixing chamber 10. The result is that because in this example the volume of the storage space 8a is approximately equal to the volume of the storage space 8b, the storage space 8a is empty first. When the storage space 8a is empty, while the storage space 8b is not yet empty, then, only milk concentrate will be supplied to the mixing chamber 10. As a result, only frothed milk will be formed which then ends up on the coffee already received in the mug 40. Again, this frothed milk will float on top of the coffee and form a pretty white froth layer. Thus, once more, a cappuccino is formed.

It is also possible that the through-flow opening 64a and the through-flow opening 64b have, for instance, a similar size. It may be such that for instance the volume of the storage space 8a is smaller than the volume of the storage space 8b. Here, it can also be provided that the coffee concentrate in the storage space 8a is much stronger, that is, has a higher concentration than milk concentrate in the storage space 8b. As the through-flow openings 64a, 64b are approximately equally great, initially, the flow rate of the coffee concentrate will be approximately equal to the flow rate of the milk concentrate. Here, the starting point is that both concentrates have the same viscosity. The result is that the storage space 8a will be empty sooner than the storage space 8b. This means that when the storage space 8a is empty, only milk concentrate is supplied from the storage space 8b to the first mixing chamber so that, once more, after initially coffee with milk has been formed in the mixing chamber, thereafter only milk is formed in the first mixing chamber. Thus, once more, a cappuccino is obtained.

It is further also possible that the volume of the storage space 8a and the storage space 8b are approximately equal. The size of the through-flow openings 64a and 64b can be equal too. Now however, it has been provided that the coffee concentrate is less viscous than the milk concentrate. The result is that when compressing the outer wall 62, it holds once more that the flow rate of the coffee concentrate from the storage space 8a is greater than the flow rate of the milk concentrate from the storage space 8b. As a result, it holds once more that, initially, both coffee concentrate and milk concentrate are supplied to the first mixing chamber 10 so that coffee is formed that leaves the first mixing chamber via the outflow opening 12 and ends up in the holder 40. When, after some time, the storage space 8a is at least virtually empty, this will not yet be the case for the storage space 8b with the milk concentrate. The milk concentrate was, after all, more viscous, so that the flow rate was smaller. That is why thereafter, at least substantially only milk concentrate will be supplied to the mixing chamber 10 so that at least substantially frothed milk is formed which, once more, ends up on top of the coffee already present in the holder 40 so that, once more, a cappuccino is formed. Such variants are all understood to fall within the framework of the invention.

With reference to FIGS. 6a and 6b, a sixth embodiment of a system according to the invention is described. Again, the system according to FIGS. 6a and 6b corresponds at least substantially to that of FIG. 1. Here too, only the differences to the system according to FIG. 1 will be briefly elucidated.

With the system according to FIG. 6 too, the exchangeable holder is provided with a plurality of storage spaces 8a and 8b, in this example two, separated from each other, which are each filled with a fluid. In this example, the storage space 8a is, once more, filled with a coffee concentrate while the storage space 8b is filled with a milk concentrate. In this example, the storage spaces 8a and 8b are each at least substantially identical to the storage space 8 as discussed with reference to FIG. 1. They are therefore at least virtually completely separated storage spaces, while no joint wall is involved either, as was the case with FIG. 5. The storage space 8a terminates, via the fluid communication 14a, into the first mixing chamber 10. The storage space 8b terminates, via the fluid communication 14b, into the first mixing chamber 10. It further holds, once more, that the fluid communication 14a is closed off by a breakable skin 38a while the fluid communication 14b is closed off by a breakable skin 38b. As can be seen in the drawing, the fluid communications 14a and 14b terminate together in a joint outflow opening 66. An underside of this outflow opening is shown in FIG. 6b. Instead of a breakable skin 38a and 38b, per fluid communication 14a, 14b, also, one breakable skin 38 could be provided for closing off the joint outflow opening 66. In this example however, this is not the case. As can be seen in FIG. 6a, the first storage space 8a is located between two pressing members 28a and 28b. The second storage space 8b is located between two pressing members 28b and 28c. The pressing members 28a, 28b, 28c are connected to the drive 34 via arms 30a and 30c, respectively. The drive 34 can move the arm 30a in the direction of the arm 30b so that the storage space 8a is slowly squeezed empty. Independently thereof, the drive 34 can move the arm 30c in the direction of the arm 30b for gradually squeezing the storage space 8b empty. In this manner, the system is in fact provided with a plurality of dosing devices for compressing mutually different storages spaces 8a and 8b by means of different dosing devices.

In this manner it is possible to squeeze the storage spaces 8a and 8b empty in mutually different paces and/or during mutually different periods. For instance, for preparing a beverage, first, the concentrate from the storage space 8a can be supplied to the first mixing chamber and then the concentrate from the storage space 8b can be supplied to the first mixing chamber. The result is for instance that first, coffee is formed in the first mixing chamber and then milk. Here, further, the air inlet may comprise the valve 50 mentioned. The code reading unit 52 reads, for instance, the code when the inlet opening 16 and the outlet opening 18 are interconnected in a fluid-tight manner. This code 52 comprises information which is related to the type of fluids with which the first storage space 8a and the second storage space 8b, respectively, are filled, in this example coffee concentrate and milk concentrate, respectively. If, thus, the holder is intended for the preparation of cappuccino, the control device 34 can determine this on the basis of the read-out code. To this end, when for instance the button 36 is pushed again, the control device will first, by means of the drive 32, start moving the pressing member 28a in the direction of the pressing member 28b. As a result, first, coffee concentrate will be supplied from the storage space 8a to the mixing chamber 10. Simultaneously, the control device 34 can for instance provide that the air inlet valve 50 is closed. When the air inlet valve 50 is closed and, with the aid of the fluid dispensing device 6, hot water is supplied under pressure to the restriction 20 (at the same time or just after the dosing of the coffee concentrate has started), a jet of water is generated while no air is drawn in via the air inlet opening 42. The hot water will mix with the coffee extract while at least substantially no air is whipped into the coffee. First, via the outflow opening 12, the coffee extract will be dispensed without this being provided with a fine-bubble froth layer. When, after some time, the storage space 8a is at least virtually empty, the control device 34 will provide that subsequently, the pressing member 28c is moved in the direction of the pressing member 28b. As a result, the second storage space 8b is slowly squeezed empty. Thus, milk concentrate is supplied to the mixing chamber 10. Now, the control device 34 can provide that the air valve 50 is opened. As a result, the jet of hot water which is generated with the aid of the restriction 20, draws air along into the first mixing chamber. In this manner, in the first mixing chamber milk is formed with whipped-in air. This milk therefore comprises a fine-bubble froth layer. When, thereafter, the hot milk is supplied via the outflow opening 12 to the coffee extract, the frothed milk will float on the coffee extract so that, once more, a cappuccino is formed. The fluid dispensing device can continue to dispense hot water when the storage space 8a is empty and, after that, the storage space 8b is squeezed empty. The fluid dispensing device can also be temporarily stopped when a switch is made from dispensing coffee concentrate to dispensing milk concentrate.

In FIGS. 7a and 7b, a seventh embodiment according to the invention is shown. The embodiment according to FIGS. 7a and 7b corresponds substantially to the embodiment according to FIGS. 6a and 6b. Hereinafter, only the differences will be described. In the embodiment according to FIGS. 7a and 7b, it holds, as it did with the embodiments outlined hereinabove, that each storage space is manufactured, at least partly, from a movable wall which is movable relative to the rest of the respective storage space so that through movement of the wall, a volume of the respective storage space can be varied. In this example, the storage spaces 8a and 8b are formed by a rigid cylindrical outer wall 78 and a joint, rigid partition wall 80 (see also FIG. 7c). The storage space 8a is further provided with a movable, rigid wall 82 and the storage space 8b is provided with a movable rigid wall 84. The movable wall 82 is movable relative to the rest of the respective storage space 8a. It further holds that the movable wall 84 is movable relative to the rest of the storage space 8b. The dosing device 24 is provided with a first actuator comprising a rod 85 and the drive 32 for moving the rod 85 downwards. When moving downwards, the rod 85 will contact the wall 82 and then start pressing against the wall 82, thereby moving it downwards so that the volume of the storage space 8a is reduced for dispensing in a dosed manner the second fluid present in the storage space 8a. The dosing device 24 is further provided with a second actuator comprising a rod 86 and the drive 32 for moving the rod 86 downwards so that when the rod 86 moves downwards, it will contact the wall 84 for moving the wall 84 downward. If the wall 84 moves downwards, the volume of the second storage space 8b is reduced for dispensing the second fluid from the second storage space to the first mixing chamber. The operation of the apparatus according to FIG. 7 is further completely analogous to that as described with reference to FIGS. 6a and 6b. In this example, the rod 85 can be moved upwards and downwards independently of the rod 86. Dosing from the first storage space and the second storage space can therefore be controlled independently of each other. This concerns both the flow rate and the time/period that can be mutually varied for dispensing the fluids from the two storage spaces.

It is also conceivable that the rod 85 and 86 are interconnected by means of a cross arm 88, which cross arm is connected to the drive 32 by means of a rod 90. All this entails that in that case, the wall 82 and the wall 84 are driven by means of one and the same actuator. The rod 86 may then also, for instance, be longer than the rod 85 so that when the rods 85 and 86 move downwards simultaneously, first the wall 84 will start moving downwards so that initially, for instance, dispensing milk concentrate from the storage space 8b is started, and that only after this, when the wall 84 has already moved downwards somewhat, the rod 85 will contact the wall 82 so that then, the wall 82 too will move downward together with the wall 84. From that moment, also coffee concentrate is supplied from the storage space 8a to the first mixing chamber. The result is that first, only milk concentrate is supplied to the first mixing chamber so that initially, only milk is prepared which is supplied to the holder 40. After that, coffee with milk is supplied to the holder 40. Thus, once again as described hereinabove, and when furthermore, in any case during the period in which only milk concentrate is supplied to the first mixing chamber, the air inlet opening is opened and air is whipped into the milk so that frothed milk is dispensed, a good cappuccino can be prepared. The fact is that first, only frothed milk is dispensed and after that coffee (optionally frothed when the air inlet opening is still open) with milk is dispensed.

In FIG. 9 it is shown that the movable wall 9 which bounds at least a part of the at least one storage space, may be manufactured from a deformable or flexible material such as soft plastic. Here, the movable wall can also have a concertina-shaped structure so that it can be compressed in the direction of the arrow Z (see FIG. 9) for dispensing the fluid in a dosed manner. To this end, the system is provided with a rod 24 which can press the horizontal wall portion 9 downwards in the direction of the arrow Z while driving the drive 32 so that the vertical walls portions “fold together”.

The system according to FIG. 10 to be described hereinafter corresponds to a large extent to the system of FIG. 1. In the following, the differences between the system of FIG. 1 and the system of FIG. 10 will be further elucidated.

In FIG. 10 it is shown that the system according to the invention may further be provided with a second mixing chamber 100 which forms a fluid communication between the first mixing chamber 10 and the outflow opening 12. The outflow opening 12 is located in a bottom 102 of the second mixing chamber 100. The second mixing chamber 100 forms a part of the exchangeable holder 2.

In this example too it holds that the system is further provided with a restriction 20 included in the fluid flow path 21 which reaches, via the outlet opening 18, the inlet opening 16 and the first mixing chamber 10 (and, in this example also via the second chamber 100), from the fluid dispensing device 6 to the outflow opening 12. In this example, the restriction 20 is located in a fluid communication 104 between the first mixing chamber 10 and the second mixing chamber 100. The restriction 20 is designed such that, in use, with the restriction, a jet of the beverage is generated which spouts into the second mixing chamber 100. In this example too, the system is provided with an air inlet opening 42 for supplying air to the beverage in the system.

In this example, the air supply opening 42 terminates, via the fluid communication 44, downstream of the restriction 20 and upstream of the second mixing chamber 100, in the fluid flow path 21 (in this example in the fluid communication 104).

The operation of the system is as follows. Completely analogously to what is discussed with FIG. 1, first, the removable closures will be removed and the holder will be connected to the apparatus. By pushing the button 36, the control device 34 will provide that the dosing device 24 starts dispensing the second fluid to the first mixing chamber 10. Simultaneously or soon after, the control device 34 provides for the fluid dispensing device 6 to start dispensing the first fluid under pressure to the first mixing chamber. In the first mixing chamber, the first fluid and the second fluid will mix together so that the beverage is formed. The first mixing chamber 10 will be gradually filled with the beverage. When the first mixing chamber is full, in that the dosing device continues to supply the second fluid under pressure to the first mixing chamber 10 and the fluid dispensing device continues to supply the first fluid under pressure, the pressure in the first mixing chamber will rise so that the beverage is pressed from the restriction 20 out of the first mixing chamber 10. The result is that with the restriction 20, a jet of the beverage is formed which spouts into the second mixing chamber 100. Also, as a result of the venturi effect, air will be drawn in via the air inlet opening 42. This air too flows to the second mixing chamber 100.

In the second mixing chamber 100 the jet will impact on the bottom 102 for whipping in air. The beverage and the air will mix together so that air is whipped into the beverage. The beverage with the whipped-in air then flows from the second mixing chamber 100 via the outflow opening 12 as the beverage with a fine-bubble froth layer.

In the second mixing chamber 100, a further jet impact element 106 can be included (shown in interrupted lines in FIG. 10) while the restriction 20 is positioned relative to the jet impact element such that in use, the jet impacts on the impact element for whipping air into the beverage as discussed with reference to FIG. 4. Completely analogously to what is described hereinabove, when no air needs to be whipped in, the air inlet opening 42 can be closed or be omitted.

It is noted that each of the embodiments according to FIGS. 1-9 can be provided with a second mixing chamber 100 as discussed with reference to FIG. 10.

Further, with the apparatus according to FIG. 10, the air inlet opening 42 can also be positioned as shown in, for instance, FIG. 1. Air is then drawn in and supplied to the first fluid. Via the first fluid, the air then enters the first mixing chamber and will mix with the beverage obtained there. The jet formed with the restriction 20 will then also comprise air. After impact of the jet in the second mixing chamber, once more, a beverage with a fine-bubble froth layer will be formed.

In the examples given hereinabove, with the dosing device the second fluid can be dispensed under pressure to the first chamber. As a result, in the embodiment according to FIG. 10, the beverage cannot flow back into the storage space 8. It is also conceivable that the dosing device relates to an active dosing device which dispenses the second fluid by means of a pump.

In each of the outlined embodiments, the first fluid can consist of a gas such as steam. In such a case, the second fluid will often already contain a beverage to which the gas is added in the first mixing chamber 10, for instance for heating the beverage. The gas can also comprise carbon dioxide (CO₂) for obtaining a carbonated beverage. Also, the first fluid can comprise both a liquid and a gas.

In each of the embodiments according to FIGS. 1-10, further, the restriction can be omitted. However, the first and/or second fluid must then be supplied to the first mixing chamber 10 at a sufficiently great flow velocity in order that the first and second fluid will mix together well. Also, according to the invention, the restriction can be designed such that a mist is generated with the restriction. With the variants according to FIGS. 1-9, this entails that a mist of the first fluid is generated in the first chamber. To this end, the restriction can be manufactured from rubber with a through-feed opening whose diameter can vary slightly when the first fluid is supplied, for atomizing the first fluid. The atomized first fluid and the second fluid mix together whereby the beverage with whipped-in air is obtained. The beverage can then leave the first chamber with a fine-bubble froth layer. If the beverage comprises relatively large air bubbles, these can be stopped or broken by adjusting the size of the outflow opening. The large bubbles may for instance not pass the outflow opening so that a beverage with a fine-bubble froth layer is dispensed. With the variant according to FIG. 10, this entails that a mist of the beverage is generated in the second chamber 100. As a result, air is whipped into the beverage. The beverage can then leave the second chamber with air whipped in. The beverage can then flow via the outflow opening from the holder with a fine-bubble froth layer as described hereinabove.

In the embodiments outlined hereinabove, the first fluid is supplied to the first mixing chamber during at least a first period and the second fluid is supplied to the first mixing chamber during at least a second period.

Here, the first and second period may start at the same time and end at the same time. It is also possible that the second period starts sooner than the first period. However, other variations are possible too.

Further, the fluid dispensing device 6 can be designed to dispense, at wish, different types of first fluids, such as steam, water, CO₂ etc. Once more, the selection hereof can be controlled by the control unit 34 and will often coincide with the type of second fluid or second fluids in the exchangeable holder. Also, if desired, this choice can be set manually or be determined with the aid of the code reading unit 52.

The invention is not limited in any manner to the embodiments outlined hereinabove. In the embodiment according to FIG. 5, the storage spaces are located next to each other. It is also possible that the storage spaces lie one above the other as schematically shown in FIGS. 8a and 8b. With the embodiment of FIG. 6a, the restriction and the air inlet opening belong to the holder, this in contrast to what is the case in FIG. 1. Naturally, also in FIG. 6a, the restriction and/or the air inlet can be fixedly connected to the apparatus. In the example, the storage spaces were filled with coffee concentrate and/or milk concentrate. Other fluids, based or not based on concentrate are also conceivable, for instance a syrup for preparing a lemonade can be considered here. The apparatus may also be further provided with additional storage spaces which are filled with, for instance, additives such as for instance soluble powders or concentrates. These powders too can be added to the first mixing chamber by, for instance, squeezing the respective storage space empty. Here, for instance flavour enhancers, sugars, cocoa and the like can be involved. Also, milk powder and/or milk creamer can be involved. Generally, it holds that instead of a concentrate, also a powder and the like, soluble in the liquid such as water, can be added. Such variants are each understood to fall within the framework of the invention. The temperature of the first fluid can vary. For instance, the first fluid can also consist of water at room temperature or cold water. Also, the temperature of the first fluid that is supplied to the holder for preparing a beverage can vary over time. Instead of tearable skins, the closures 38 can also comprise valves known per se which, to be opened, are operated by the apparatus. Pressing the storage spaces empty can also be carried out in a different manner such as, for instance, pressing empty with the aid of a force generated by air pressure. This force, in turn, can act on the outsides of the storage space. The closure 17 can also be of a different design than a removable seal. For instance, the closure can be provided with a valve which may be operated by hand or by the apparatus. The closure may also be formed by a tearable skin which tears open under the influence of the pressure of a mixture of fluid and liquid in the mixing chamber.

The volume of a storage space can vary from, for instance, 5 to 150 millilitres, more particularly from 6 to 50 millilitres. A passage of the restriction can vary from, for instance, 0.4 to 1.5 millimetre, more particularly from 0.6 to 1.3 millimetre, still more particularly from 0.7 to 0.9 millimeters. The pressure at which, in use, the liquid dispensing device dispenses the first fluid can vary from 0.6 to 12 bar, more particularly from 0.7 to 2 bars and preferably from 0.9 to 1.5 bar. The period during which the first fluid is supplied to the first mixing chamber for preparing the beverage can vary from 2 to 90 seconds, more particularly from 10 to 50 seconds. The size of the air inlet opening, if this is completely opened, can vary from, for instance, 0.005 to 0.5 mm².

1-87. (canceled)

88. A system for preparing a predetermined amount of beverage suitable for consumption, including:
an exchangeable holder; and
an apparatus provided with a fluid dispensing device for dispensing at least one amount of at least a first fluid including at least one of water and steam, under pressure to the exchangeable holder, wherein the exchangeable holder is provided with at least one storage space which is filled with a second fluid including a concentrate,
wherein the holder is further provided with at least a first mixing chamber, at least one outflow opening which is in fluid communication with the first mixing chamber for dispensing the beverage from the first mixing chamber, at least one fluid communication between the storage space and the first mixing chamber for dispensing the second fluid to the first mixing chamber and at least one inlet opening which is detachably connected to an outlet opening of the fluid dispensing device for removably connecting the holder to the fluid dispensing device and for supplying the first fluid to the first mixing chamber, the system being further provided with
a dosing device which is arranged to supply the second fluid in a dosed manner from the storage space to the first mixing chamber, wherein the fluid dispensing device is arranged to supply the first fluid under pressure to the first mixing chamber so that in the first mixing chamber the first fluid and the second fluid mix together for obtaining the beverage which thereupon leaves the exchangeable holder via the outflow opening, wherein the system is further provided with a restriction which is included in a fluid flow path which reaches from the fluid dispensing device to the outflow opening, via the outlet opening of the fluid dispensing device, the inlet opening of the holder and the first mixing chamber, and wherein the system is provided with an air inlet opening for supplying air to the beverage in the system.

89. The system of claim 88, wherein the dosing device relates to a controllable, active dosing device for supplying the second fluid to the first mixing chamber by means applying one of an increased pressure and an increased force to the second fluid.

90. The system of claim 89, wherein the system is further provided with a control device for controlling the dosing device and the fluid dispensing device.

91. The system of claim 88, wherein the system is arranged such that the fluid dispensing device and the dosing device can supply the first fluid and the second fluid, respectively, to the first mixing chamber independently of each other.

92. The system of claim 88, wherein the restriction is included in a fluid flow path which reaches from the fluid dispensing device to the first mixing chamber.

93. The system of claim 92, wherein the restriction is arranged for generating in use a jet of the first fluid, which spouts into the first mixing chamber.

94. The system of claim 92, wherein the restriction is arranged for generating in use a mist from the first fluid which flows into the first mixing chamber.

95. The system of claim 93, wherein the dosing device is arranged to supply the second fluid in a dosed manner from the storage space to the first mixing chamber while the fluid dispensing device supplies the first fluid under pressure to the fluid flow path.

96. The system of claim 88, wherein the system is further provided with a second mixing chamber which forms a fluid communication between the first mixing chamber and the outflow opening.

97. The system of claim 96, wherein the restriction is included between the first mixing chamber and second mixing chamber.

98. The system of claim 97, wherein the restriction is arranged for generating, in use, a jet of the beverage, which spouts into the second mixing chamber.

99. The system of claim 97, wherein the restriction is arranged for generating in use, a mist of the beverage, which flows into the second mixing chamber.

100. The system of claim 88, wherein the system is provided with an air inlet opening for supplying air to the first mixing chamber for whipping, in use, air into the beverage for obtaining a beverage with a fine-bubble froth layer.

101. The system of claim 88, wherein the restriction is included in a fluid flow path which reaches from the fluid dispensing device to the first mixing chamber, and wherein downstream of the restriction the air inlet opening is in fluid communication with the first mixing chamber.

102. The system of claim 88, wherein the restriction is included in a fluid flow path which reaches from the fluid dispensing device to the first mixing chamber, and wherein the air inlet opening terminates via a fluid communication into the fluid flow path.

103. The system of claim 88, wherein the system is further provided with a second mixing chamber which forms a fluid communication between the first mixing chamber and the outflow opening, and wherein the system is provided with the air inlet opening for supplying air to the second mixing chamber.

104. The system of claim 88, wherein the air inlet opening forms part of the holder.

105. The system of claim 88, wherein the air inlet opening forms part of the apparatus.

106. The system of claim 88, wherein the restriction forms part of the holder.

107. The system of claim 88, wherein the storage space is bounded, at least partly, by a movable wall which is movable relative to the rest of the storage space so that through movement of the wall, a volume of the storage space can be varied.

108. The system of claim 88, wherein the storage space is bounded, at least partly, by a wall manufactured from one of a flexible or a deformable material including a foil.

109. The system of claim 107, wherein between the storage space and the first mixing chamber, a closure is present which will open when the pressure applied by the second fluid to the closure rises above a predetermined value.

110. The system of claim 107, wherein the dosing device is provided with at least one actuator for moving the wall so that the volume of the storage space can be reduced for dispensing the second fluid to the first mixing chamber in a dosed manner.

111. The system of claim 88, wherein the dosing device is provided with at least one actuator for compressing the storage space for dispensing the second fluid in a dosed manner to the first mixing chamber through compression

112. The system of claim 88, wherein the exchangeable holder is provided with a plurality of storage spaces, separated from each other, which are each filled with a second fluid.

113. The system of claim 112, wherein each storage space is bounded, at least partly, by a movable wall which is movable relative to the rest of the respective storage space so that through movement of the movable part of the wall, a volume of the respective storage space can be varied.

114. The system of claim 112, wherein each storage space is bounded, at least partly, by a wall manufactured from one of a flexible and a deformable material including a foil so that through movement of the outer wall, the volume of the respective storage space can be varied.

115. The system of claim 112, wherein the holder is provided with a plurality of fluid communications which each form a fluid communication between one of the storage spaces and the first mixing chamber.

116. The system of claim 112, wherein between each storage space on the one side and the first mixing chamber on the other side, a closure is present which will open when the pressure which is applied by one of the fluids to the closure rises above a particular value.

117. The system of claim 116, wherein at least a number of the closures will open at mutually different pressures.

118. The system of claim 112, wherein at least two storage spaces are filled with fluids which have a mutually different viscosity.

119. The system of claim 112, wherein the dosing device is provided with at least one actuator for moving the movable walls of the storage spaces for reducing the volumes of the storage spaces for dispensing the fluids in a dosed manner from the different storage spaces to the first mixing chamber.

120. The system of claim 112, wherein the dosing device is provided with at least one actuator for compressing the storage spaces for dispensing the fluids in a dosed manner from the different storage spaces to the first mixing chamber through compression.

121. The system of claim 119, wherein each fluid communication forms a communication, via a through-flow opening, between one of the storage spaces and the first mixing chamber wherein the size of a number of the through-flow openings are chosen to be mutually different, for dispensing the fluids from the different storage spaces at mutually different flow rates with the aid of the actuator.

122. The system of claim 119, wherein the dosing device is provided with a plurality of actuators for dispensing fluids, with different dosing devices, in a dosed manner, from mutually different storage spaces to the first mixing chamber.

123. The system of claim 112, wherein the system is arranged to at least one of dispense fluids from at least two storage spaces, at mutually different flow rates and during mutually different periods.

124. The system of claim 122, wherein the system is arranged to at least one of dispense fluids with mutually different flow rates and during mutually different periods with at least two different actuators from at least two storage spaces.

125. The system of claim 88, wherein the air inlet opening is provided with an adjustable valve for setting the size of the airflow.

126. The system of claim 88, wherein the holder is provided with a code and the apparatus is provided with a code reading unit for reading the code and a control device which controls the apparatus depending on the code that is read.

127. The system of claim 126, wherein, depending on the code read by the code reading device, the control unit controls the liquid dispensing device for determining at least one of pressure, amount and temperature of the liquid which, in use, is supplied to the holder.

128. The system of claim 126, wherein the control device controls the adjustable valve depending on the code that is read.

129. The system of claim 93, wherein the first mixing chamber is provided with an inside wall, the restriction being positioned relative to the inside wall such that in use, the jet spouts against the inside wall.

130. The system of claim 93, wherein in the first mixing chamber, a jet impact element is included, the restriction being is positioned relative to the jet impact element such that, in use, the jet impacts on the jet impact element.

131. The system of claim 88, wherein in an inside wall of the first mixing chamber an opening is present which provides the first mixing chamber with a fluid communication to the outflow opening.

132. The system of claim 98, wherein the second mixing chamber is provided with an inside wall whereby the restriction is positioned relative to the inside wall such that, in use, the jet spouts against the inside wall.

133. The system of claim 98, wherein in the second mixing chamber, a jet impact element is included whereby the restriction is positioned relative to the jet impact element such that, in use, the jet impacts on the jet impact element.

134. The system of claim 88, wherein the fluid dispensing device is detachably connected to the holder for dispensing at least one amount of at least one liquid including water under pressure to the exchangeable holder, whereby the outflow opening is in fluid communication with the first mixing chamber for dispensing the beverage from the first mixing chamber, the system being further provided with a restriction, included in a fluid flow path forming a liquid flow path and which reaches from the fluid dispensing device to the first mixing chamber, via the outlet opening of the fluid dispensing device and the inlet opening of the holder, the dosing device being arranged to supply the second fluid in a dosed manner from the storage space to the first mixing chamber while the fluid dispensing device supplies the liquid under pressure to the liquid flow path so that with the restriction, a jet of the liquid is generated which spouts into the first mixing chamber while in the first mixing chamber, the second fluid and the liquid mix together for obtaining the beverage which then leaves the first mixing chamber via the outflow opening.

135. An exchangeable holder arranged to be connected to an apparatus provided with a fluid dispensing device for dispensing at least a first fluid including one of a gas and a liquid under pressure to the exchangeable holder for preparing a beverage suitable for consumption, the exchangeable holder being provided with at least one storage space which is filled with a second fluid including a concentrate, wherein the holder is further provided with at least a first mixing chamber, at least one outflow opening which is in fluid communication with the first mixing chamber for dispensing the beverage from the first mixing chamber, at least one fluid communication between the storage space and the first mixing chamber for dispensing the second fluid to the first mixing chamber and at least one inlet opening which, in use, is detachably connected to an outlet opening of the fluid dispensing device for supplying the first fluid to the first mixing chamber, wherein the storage space forms part, at least partly, of a dosing device and is thereto bounded, at least partly, by a movable wall which is movable relative to the rest of the storage space so that through movement of the movable wall, a volume of the storage space can be reduced for dispensing the second fluid in a dosed manner from the storage space to the first mixing chamber while, in use, the first fluid is also supplied under pressure to the mixing chamber so that the second fluid and the first fluid mix together for obtaining the beverage which, then, leaves the holder via the outflow opening, wherein the holder is further provided with a restriction which is included in a fluid flow path which reaches from the inlet opening of the holder to the outflow opening, and wherein the holder is provided with an air inlet opening for supplying air to the beverage in the holder.

136. The holder of claim 135, wherein the storage space is bounded, at least partly, by a wall of one of flexible and deformable materials including a foil so that the storage space can be compressed for dispensing the second fluid from the storage space to the first mixing chamber.

137. The holder of claim 135, wherein the restriction is included in a fluid flow path which reaches from the inlet opening to the first mixing chamber.

138. The holder of claim 137, wherein the restriction is arranged for generating, in use, a jet of the first fluid, which spouts into the first mixing chamber.

139. The holder of claim 137, wherein the restriction is arranged for generating, in use, a mist from the first fluid, which flows into the first mixing chamber.

140. The holder of claim 135, wherein the system is further provided with a second mixing chamber which forms a fluid communication between the first mixing chamber and the outflow opening.

141. The holder of claim 135, wherein the system is further provided with a second mixing chamber which forms a fluid communication between the first mixing chamber and the outflow opening, and wherein the restriction is included between the first mixing chamber and the second mixing chamber.

142. The holder of claim 141, wherein the restriction is arranged for generating, in use, a jet of the beverage, which spouts into the second mixing chamber.

143. The holder of claim 141, wherein the restriction is arranged for generating, in use, a mist from the beverage, which flows into the second mixing chamber.

144. The holder of claim 135 wherein the holder is provided with an air inlet opening for supplying air to the first mixing chamber for whipping, in use, air into the beverage for obtaining a beverage with a fine-bubble froth layer.

145. The holder of claim 144, wherein the restriction is included in a fluid flow path which reaches from the inlet opening to the first mixing chamber, and wherein downstream of the restriction the air inlet opening is in fluid communication with the first mixing chamber.

146. The holder of claim 144, wherein the restriction is included in a fluid flow path which reaches from the inlet opening to the first mixing chamber, and wherein the air inlet opening terminates via a fluid communication in the fluid flow path.

147. The holder of claim 135, wherein the system is further provided with a second mixing chamber which forms a fluid communication between the first mixing chamber and the outflow opening, and wherein the holder is provided with the air inlet opening for supplying air to the second mixing chamber.

148. The holder of claim 135, wherein between the storage space and the first mixing chamber a closure is present which will open when the pressure which is applied by the second fluid to the closure rises above a predetermined value.

149. The holder of claim 135, wherein the exchangeable holder is provided with a plurality of storage spaces, separated from each other, which are each filled with a second fluid.

150. The holder of claim 149, wherein each storage space is bounded, at least partly, by a movable wall which is movable relative to the rest of the respective storage space so that through movement of the movable part of the wall, a volume of the respective storage space can be varied.

151. The holder of claim 149, wherein each storage space is bounded, at least partly, by a wall manufactured from at least one of a flexible or a deformable material including a foil so that through movement of the wall, a volume of the respective storage space can be varied.

152. The holder of claim 149, wherein the holder is provided with a plurality of fluid communications which each form a fluid communication between one of the storage spaces and the first mixing chamber.

153. The holder of claim 149, wherein between each storage space on the one side and the first mixing chamber on the other side, a closure is present which will open when the pressure which is applied by one of the fluids to the closure rises above a predetermined value.

154. The holder of claim 153, wherein at least a number of the closures will open at mutually different pressures.

155. The holder of claim 149, wherein at least two storage spaces are filled with fluids which have a mutually different viscosity.

156. The holder of claim 152, wherein each fluid communication, via a through-flow opening, forms a communication between one of the storage spaces and the first mixing chamber wherein the size of a number of the through-flow openings are chosen to be mutually different, for dispensing the fluids from the different storage spaces at mutually different flow rates with the aid of the actuator.

157. The holder of claim 149, wherein the holder is arranged to at least on of dispense fluids from at least two storage spaces at mutually different flow rates and during mutually different periods.

158. The holder of claim 135, wherein the at least one air inlet opening is provided with an adjustable valve for setting the size of the airflow.

159. The holder of claim 135, wherein the holder is provided with a code that can be read with a code reading unit.

160. The holder of claim 135, wherein the first mixing chamber is provided with an inside wall whereby the restriction is positioned relative to the inside wall such that, in use, the jet spouts against the inside wall.

161. The holder of claim 138, wherein in the first mixing chamber a jet impact element is included wherein the restriction is positioned relative to the jet impact element such that, during use, the jet impacts on the jet impact element.

162. The holder of claim 135, wherein in an inside wall of the first mixing chamber an opening is present which provides the first mixing chamber with a fluid communication to the outflow opening.

163. The holder of claim 141, wherein the second mixing chamber is provided with an inside wall wherein the restriction is positioned relative to the inside wall such that, during use, the jet impacts against the inside wall.

164. The holder of claim 142, wherein in the second mixing chamber a jet impact element is included wherein the restriction is positioned relative to the jet impact element such that, during use, the jet impacts on the jet impact element.

165. The holder of claim 135, wherein the inlet opening is provided with a removable closure including a seal.

166. The holder of claim 135, wherein the outflow opening is provided with a removable closure including a seal.

167. The holder of claim 135, wherein the fluid dispensing device is arranged to dispense a first fluid in the form of a liquid under pressure to the holder whereby the outflow opening is in fluid communication with the first mixing chamber for dispensing the beverage from the first mixing chamber, while, in use, the liquid is also supplied under pressure to the mixing chamber so that the second fluid and the liquid mix together for obtaining beverage which, then, leaves the mixing chamber via the outflow opening.
